(19) United States
(12) Patent Application Publication
(10) Pub. No.: US 2011/0089076 A1
(43) Pub. Date: Apr. 21, 2011

(54) PACKAGING SYSTEM

(76) Inventor: Norman Niven, Stockport (GB)

(21) Appl. No.: 12/736,429

(22) PCT Filed: Apr. 8, 2009
(86) PCT No.: PCT/IB2009/051492

§ 371 Date: Dec. 10, 2010

(30) Foreign Application Priority Data
Apr. 7, 2008 (GB) 0806277.0

(51) Int. Cl. A61J 1/16; B65D 1/34; B65D 51/00

(52) U.S. Cl. 206/538; 206/459.5; 206/559; 215/232

(57) ABSTRACT

A container for discretely packaging liquid or solid medication, or other substances, comprising a tray (10) with individual compartments (12) each containing a removable pot (17) and a perforated sealed sheet (21) enabling individual pots to be removed from the tray (10) for dispensing of its contents The perforated sealed sheet (21) is of laminated construction and comprises an upper layer (30) of CPET which is surface-treated to be ink jet printable, an intermediate layer (33) bonded to the layer (30) and sealingly attachable to the tray (10). A removable paper backing layer (34) provides sufficient structural rigidity to enable the flexible laminated sheet (21) to pass through an ink yet printer whereby details of the intended contents of the pots (17) may be printed on the sheet (21).

This invention relates to a system for discretely packaging a plurality of quantities of one or more fluid or solid substances.

Particularly, though not exclusively, the system has been devised to meet the needs of patients and carers in the safe, accurate and convenient monitored dispensing of medication both in liquid and solid forms. Liquid medication, apart from the use of individual sachets or blisters, is currently supplied to the patient or carer in large containers from which individual doses are dispensed, usually into a measuring spoon or cup from which the patient takes the medicine.

It is of the utmost importance that a patient should take an accurate dose of the correct medicine and that there should be no risk of confusion or of cross-contamination between patients should a large bottle of medication be used, perhaps improperly, to dispense the medication to different patients.

Conventionally, and particularly in care homes, it is necessary for large numbers of such bottles to be stored, and this takes up considerable space. Furthermore, since the medication is contained in a large bottle then as the quantity in the bottle diminishes an increasing air space above the liquid is created which can adversely affect the chemical properties of the medicine.

It is an object of the present invention to provide a system of accurately and conveniently packaging individual doses of medication, whether in liquid or tablet form, and which is more easily managed in a safe and convenient manner, thus substantially avoiding the aforementioned difficulties.

According to the present invention there is provided a container for discretely packaging a plurality of quantities of one or more fluid or solid substances, and comprising a tray having a plurality of individual spaced removable vessels adapted to contain the substances to be packaged, means releasably to retain the vessels in the tray prior to intended removal, and a flexible sheet sealingly to retain the substances in the vessels prior to their intended use, characterised in that the sheet is of laminated construction comprising an upper layer having a surface printably receptive to polyvinyl alcohol ink, an intermediate layer of a heat-sealable polyethylene film, and a peelable backing layer of a material providing structural stability to enable the laminated sheet to pass through an inkjet printer.

The tray may include individual spaced compartments, the vessels being individually removably received within the respective compartments.

The compartments may be pre-formed integrally with the tray.

The vessels may be individual pots.

The vessels and the compartments may be of complementary shape and size.

The flexible sheet may be sealingly attached to and across an otherwise open top of each vessel.

The flexible sheet may be sealingly attached to and across the tray and all the vessels thereof with perforations to permit selective removal of the vessels individually while at least some of the vessels are retained and remain sealingly closed.

The flexible sheet may display printed matter identifying the content of each vessel.

The flexible sheet may display printed matter identifying the content of all of the vessels and the purpose for, or manner in which, the contents are to be used.

Each compartment may have an aperture in a base region thereof to enable the associated retained vessel to be pushed out of its compartment.

The flexible sheet attached across each vessel may be loosely superimposed upon a part of an upper surface of the associated vessel thus, after removal of the vessel from the tray, to allow the sheet to be peeled off to open the vessel to dispense the contents therefrom.

A peripheral flange may be provided around the top of each vessel, a part of which is readily deformable to assist in peeling off the sheet to open the vessel.

The upper surface layer may be a crystalline polyethylene terephthalate (CPET) surface-treated with a polyvinyl alcohol ink jet receptor for monochrome or colour printing

The upper layer may be joined to the intermediate layer by a cross-linked urethane adhesive

The intermediate layer may provide a peelable bond to the material of the tray.

The peelable backing layer may be an adhesive-coated paper.

The perforations in the flexible sheet may be defined by a plurality of snap-off ties to release each vessel together with an associated part of the flexible sheet, from the tray and from the remainder of the flexible sheet.

The upper layer may at or in the region of 75 microns in thickness.

The intermediate layer may be at or in the region of 40 microns in thickness.

An embodiment of the invention will be now be described, by way of example only, with reference to the accompanying drawings, in which

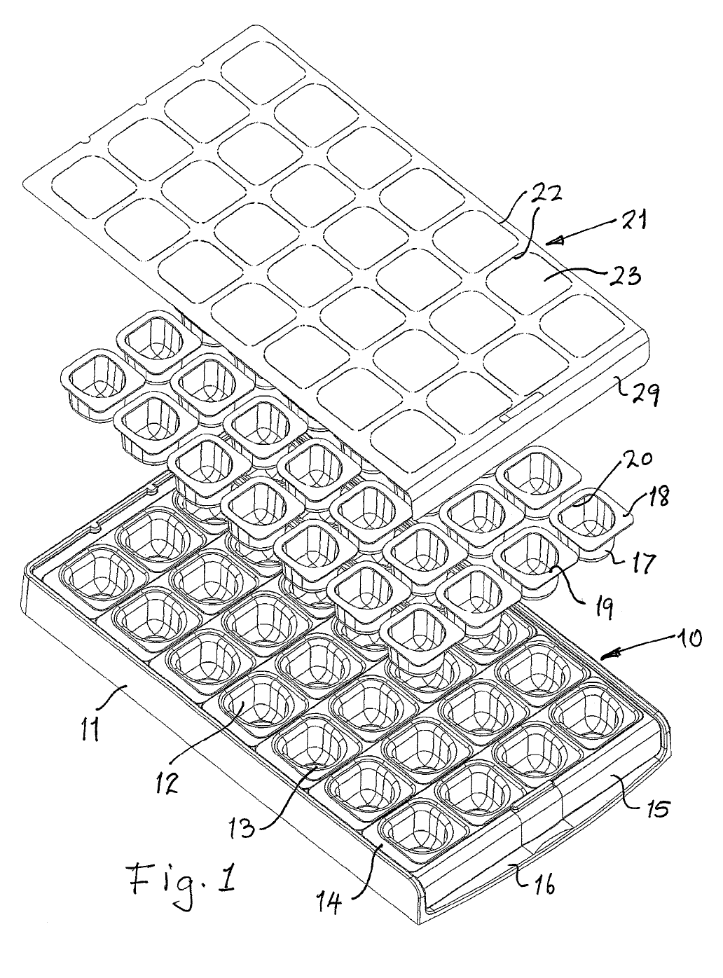

FIG. 1 is an exploded perspective view of a container made in accordance with the invention;

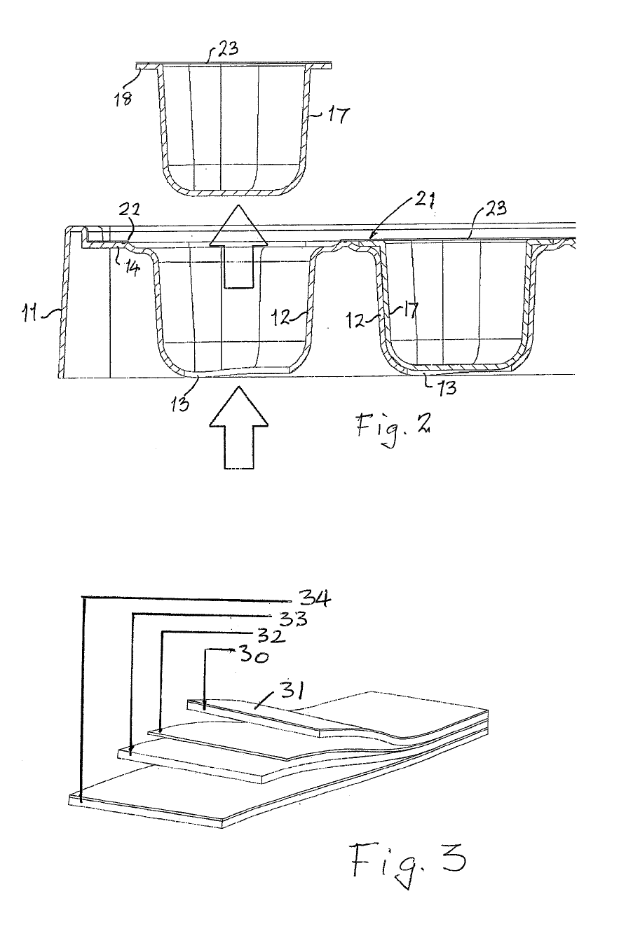

FIG. 2 is an enlarged cross-sectional view of part of the container of FIG. 1;

FIG. 3 shows the laminated structure of a flexible sheet being part of the container at FIG. 1

The following description, by way of example, is of a system for discretely packaging a plurality of quantities of medication in liquid, tablet or capsule form. Equally, the system may be used for packaging individual quantities of any substance to be dispensed as required. Thus, the system may be used for packaging small quantities of foodstuffs. However, its principal intention is to produce a monitored dosing system for medication where both the patient and the dispensing personnel can be certain that the medication is correctly and safely prepared, stored and taken. Such a system is for the benefit of not only patients and carers but also of pharmacists.

Referring now to FIGS. 1 and 2, a container made in accordance with the invention comprises a tray generally indicated at 10, of a plastics material and formed to define side walls 11 and an array of individual preformed, side-by-side compartments 12 each having an opening 13 at its base and a common upper platform 14 extending across the tray 10 between the compartments 12. A front wall 15 provides a surface for the display of data concerning the contents of the tray and a lip 16 enables the tray to be withdrawn from an outer container to be described.

Located within each compartment 12 is a vessel in the form of an individual pot 17 for containment of a substance to be packaged. Each pot 17 has an upper flange 18 which when the pot is located in the tray rests upon, and flush with, the platform 14. The pots may be of the same material as the tray 11, and are preferably transparent.

The shape of the recess defined within each pot 17 is such as to have a curved upper rim 19 at least at one side. Opposite the curved rim 19 in each pot is a straight end 20. The walls of each pot also conform to the shape of the upper rim.

For preference, each pot 17 is of such a size as to be an interference fit within its compartment which is of complementary shape and size.

With all of the pots 17 in place a pharmacist may place the appropriate medication in each pot either by using a measured pipette for liquid medication or by placing tablets or capsules into the pots in the case of solid medication.

To complete the container a flexible sheet 21 of a non-permeable material having perforations 22 is placed over the filled tray and sealed thereto to provide an air-tight and moisture-tight seal, as will be described. The perforations 22 coincide with the outer peripheries of the pots 17, thus to define individual sealed films 23, one across each pot. The sheet 21 is adhesively sealed to the platform 14 and around each individual pot flange 18 and provides therefor additional impact strength.

With the sheet in place the pots can be removed individually by pushing a pot upwards through the opening 13 in the associated compartment thus breaking the perforation in the sheet 21, while maintaining the integrity of the sealed film 23 and the remainder of the sheet 21 across the remaining pots and the platform 14. This action is shown in FIG. 2 and it can be seen that once the pot is removed, the sealed film 23 remaining on the flange 18 can be peeled off to open the pot whereupon the medication can be taken. The curved rim 19 of each pot facilitates the taking of liquid medication. The regions of the flange 18 either side of the curved rim will have sufficient flexibility that they can be deformed to assist in release of the individual sealed film 23.

In this manner, therefore, individual pots can be removed and remain sealed whilst the remainder are retained and sealed on the tray 10. The individual films 23 may be printed, for example, with a time and date and the contents of the associated pot. A front flap 29 of the sheet 21 can be printed with information pertaining to the contents of the entire tray.

To avoid any risk of contamination it is intended that the entire tray 10 be disposable.

Referring now to FIG. 3, the flexible sheet 21 comprises an upper layer 30 of crystalline polyethylene terephthalate (CPET) which has been surface treated with a polyvinyl alcohol ink jet receptive coating 31 and, if required, a silver antimicrobial protective layer to inhibit the growth of bacteria, mould and fungi by up to 99.9% over a twenty four hour period of exposure. Silver is effective against a broad spectrum of micro-organisms and, in the form of silver ions, is the active ingredient in a coating product known by the registered trade mark BioCote. The polyvinyl alcohol coating 31 enables monochrome and colour printing using standard ink jet printers.

A 3-microns cross-linked urethane adhesive layer 32 is used to bond the upper layer 30 to an intermediate layer 33 being a 40-microns co-extruded polyethylene triple laminate peelable and heat-sealable film which provides a permanent bond to the upper surface of the tray 10 and to the flanges 18 of the individual pots 17 when placed in the compartments 12.

Prior to placement of the sheet 21 on the container, a peelable paper backing layer 34 is adhesively bonded to the lower surface of the layer 33, and this paper layer provides sufficient structural stability and rigidity to enable the laminated sheet to pass through an ink jet printer. The layer 34 is readily peelable from the laminated sheet prior to its placement on the container.

As can be seen from FIG. 1, the perforations 22 enable each pot 17, with its individual sealed film 23 of the sheet 21 to be removed from the container while the film 23 remains sealingly intact on the pot, and without disturbing the sealed relationship of the remainder of the sheet 21 over the remainder of the tray and the pots contained therein.

The sheet 21 serves as a barrier to prevent UV from entering the pots 17 and their contents.

While the above description refers to a compartmented tray having individually removable pots each seated in a compartment, the vessels may themselves form the tray and be removable individually from a supporting framework or the like.

1. A container for discretely packaging a plurality of quantities of one or more fluid or solid substances, said container comprising
a tray having a plurality of individual spaced removable vessels adapted to contain the substances to be packaged,
means releasably to retain the vessels in the tray prior to intended removal, and
a flexible sheet sealingly to retain the substances in the vessels prior to their intended use,
wherein the sheet is of laminated construction comprising
an upper layer having a surface printably receptive to polyvinyl alcohol ink,
an intermediate layer of a heat-sealable polyethylene film, and
a peelable backing layer of a material providing structural stability to enable the laminated sheet to pass through an ink jet printer.

2. A container according to claim 1 wherein the tray includes individual spaced compartments, the vessels being individually removably received within the respective compartments.

3. A container according to claim 2 wherein the compartments are preformed integrally with the tray.

4. A container according to claim 1 wherein the vessels are individual pots.

5. A container according to claim 1 wherein the vessels of the compartments are of complementary shape and size.

6. A container according to claim 1 wherein the flexible sheet is sealingly attached to and across an otherwise open top of each vessel.

7. A container according to claim 1 wherein the flexible sheet is sealingly attached to and across the tray and all of the vessels thereof with perforations to permit selective removal of the vessels individually while at least some of the vessels are retained and remain sealingly closed.

8. A container according to claim 1 wherein the flexible sheet displays printed matter identifying the intended content of each vessel.

9. A container according to claim 1 wherein the flexible sheet displays printed matter identifying the intended content of all of the vessels and the purpose for, or manner in which, the intended contents are to be used.

10. A container according to claim 2 wherein each compartment has an aperture in a base region thereof to enable the associated retained vessel to be pushed out of its compartment.

11. A container according to claim 1 wherein the flexible sheet attached across each vessel is loosely superimposed upon a part of an upper surface of the associated vessel thus, after removal of the vessel from the tray, to allow the sheet to be peeled off to open the vessel to dispense the contents therefrom.

12. A container according to claim 1 wherein a peripheral flange is provided around the top of each vessel, a part of which is readily deformable to assist in peeling off the sheet to open the vessel.

13. A container according to claim 1 wherein the upper layer of the flexible sheet is a crystalline polyethylene terephthalate (CPET) surface-treated with a polyvinyl alcohol ink jet receptor for monochrome or colour printing.

14. A container according to claim 1 wherein the flexible sheet includes an antimicrobial protective coating.

15. A container according to claim 1 wherein the upper layer of the flexible sheet is joined to the intermediate thereof by a cross-linked urethane adhesive.

16. A container according to claim 1 wherein the intermediate layer of flexible sheet provides a peelable bond to the material of the tray.

17. A container according to claim 1 wherein the peelable backing layer of the flexible sheet is an adhesive-coated paper.

18. A container according to claim 7 wherein the perforations in the flexible sheet are defined by a plurality of snap-off ties to release each vessel together with an associated part of the flexible sheet, from the tray and from the remainder of the flexible sheet.

19. A container according to claim 1 wherein the upper layer of the flexible sheet is at or in the region of 75-microns in thickness.

20. A container according to claim 1 wherein the intermediate layer of the flexible sheet is at or in the region of 40-microns in thickness.
